(19) United States
(12) Patent Application Publication
(10) Pub. No.: US 2023/0005036 A1
(43) Pub. Date: Jan. 5, 2023

(54) SERVER, SYSTEM, AND CONTROL METHOD

(71) Applicant: HONDA MOTOR CO., LTD., Tokyo (JP)

(72) Inventors: Tatsuya Jinno, Wako-shi (JP); Takumi Shiiyama, Wako-shi (JP)

(73) Assignee: HONDA MOTOR CO., LTD., Tokyo (JP)

(21) Appl. No.: 17/943,903

(22) Filed: Sep. 13, 2022

Related U.S. Application Data
(63) Continuation of application No. PCT/JP2021/007401, filed on Feb. 26, 2021.

(30) Foreign Application Priority Data
Mar. 27, 2020 (JP) 2020-057892

(51) Int. Cl. G06Q 30/06; G06Q 30/02

(52) U.S. Cl. CPC G06Q 30/0609; G06Q 30/0206; G06Q 30/0633

(57) ABSTRACT

A server comprising an acquisition unit configured to acquire price information that includes a price to be paid for purchasing a battery and that is presented by a first user who desires to reuse the battery, the battery being mounted on a vehicle capable of travelling with an electric motor as a power source, a provision unit configured to provide a second user who owns the vehicle with the price information that is acquired by the acquisition unit, a decision unit configured to decide a business agency that will remove the battery from the vehicle, in a case where the second user approves selling of the battery at the price included in the price information, and a notification unit configured to notify the second user of business agency information about the business agency that is decided by the decision unit is provided.

### CROSS-REFERENCE TO RELATED APPLICATION(S)

This application is a continuation of International Patent Application No. PCT/JP2021/007401 filed on Feb. 26, 2021, which claims priority to and the benefit of Japanese Patent Application No. 2020-057892 filed on Mar. 27, 2020 the entire disclosures of which are incorporated herein by reference.

### TECHNICAL FIELD

The present invention relates to a server, a system, and a control method.

### BACKGROUND ART

In recent years, efforts have been made to promote the cyclical use of finite resources and energy (for example, reduce, reuse, and recycle) and to form recycling-oriented society that reduces the impact on the environment. In view of such social situations, a technique of establishing a comprehensive trade information site of recycling-related companies on the Internet has also been proposed (see Patent Literature 1).

Meanwhile, with increasing interest in environmental problems, vehicles capable of traveling with an electric motor as a power source, specifically, hybrid vehicles that consume less fossil fuels and electric vehicles that consume no fossil fuels have become widespread worldwide. As one of the efforts for promoting a recycling-oriented society, studies have been carried out for the reuse of a battery mounted on a hybrid vehicle or an electric vehicle as a reuse battery, when the hybrid vehicle or the electric vehicle is disposed of

### CITATION LIST

### Patent Literature

PTL 1: Japanese Patent Laid-Open No. 2003-50859

### SUMMARY OF INVENTION

### Technical Problem

There are several issues, however, in reusing the battery mounted on a hybrid vehicle or an electric vehicle, as a reuse battery. For example, in a transaction between an owner of a vehicle such as a hybrid vehicle or an electric vehicle and a purchaser who desires to reuse the battery mounted on such a vehicle, that is, desires to purchase the battery, it is necessary to decide not only a price (payment) of the battery but also a business agency that will remove the battery from the vehicle, and a date and time (timing) when the battery is to be removed from the vehicle. This is because it is often assumed that the owner of the vehicle will continuously use the vehicle until the transaction is established, and in addition, in general, the owner or the purchaser will not able to remove the battery from the vehicle (that is, it will not be possible to use the battery easily).

An object of the present invention is to provide a new technique suitable for a transaction of a battery mounted on a vehicle capable of traveling with an electric motor as a power source.

### Solution to Problem

A server as one aspect of the present invention is a server comprising an acquisition unit configured to acquire price information that includes a price to be paid for purchasing a battery and that is presented by a first user who desires to reuse the battery, the battery being mounted on a vehicle capable of travelling with an electric motor as a power source, a provision unit configured to provide a second user who owns the vehicle with the price information that is acquired by the acquisition unit, a decision unit configured to decide a business agency that will remove the battery from the vehicle, in a case where the second user approves selling of the battery at the price included in the price information, and a notification unit configured to notify the second user of business agency information about the business agency that is decided by the decision unit.

A system as another aspect of the present invention is a system comprising a server, a first terminal used by a first user who desires to reuse a battery mounted on a vehicle capable of travelling with an electric motor as a power source, and a second terminal used by a second user who owns the vehicle, wherein the server includes an acquisition unit configured to acquire price information that includes a price to be paid for purchasing the battery and that is presented by the first user via the first terminal, a provision unit configured to provide, via the second terminal, the second user who owns the vehicle with the price information that is acquired by the acquisition unit, a decision unit configured to decide a business agency that will remove the battery from the vehicle, in a case where the second user approves selling of the battery at the price included in the price information, and a notification unit configured to notify, via the second terminal, the second user of business agency information about the business agency that is decided by the decision unit.

A control method as yet another aspect of the present invention is a control method for controlling a server, the control method comprising acquiring price information that includes a price to be paid for purchasing a battery and that is presented by a first user who desires to reuse the battery, the battery being mounted on a vehicle capable of travelling with an electric motor as a power source, providing a second user who owns the vehicle with the price information that is acquired in the acquiring, deciding a business agency that will remove the battery from the vehicle, in a case where the second user approves selling of the battery at the price included in the price information, and notifying the second user of business agency information about the business agency that is decided in the deciding.

### ADVANTAGEOUS EFFECTS OF INVENTION

According to the present invention, it is possible to provide a new technique suitable for a transaction of a battery mounted on a vehicle capable of traveling with, for example, an electric motor as a power source.

Other features and advantages of the present invention will be apparent from the following description with reference to the accompanying drawings.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a schematic diagram illustrating a configuration of a transaction system as one aspect of the present invention.

FIG. 2 is a schematic block diagram illustrating a configuration of a server of the transaction system illustrated in FIG. 1.

FIG. 3 is a functional configuration diagram schematically illustrating functions of a processing unit of the server illustrated in FIG. 2.

FIG. 4 is a diagram illustrating an example of a database indicating a relationship between a degradation state of a battery and an appropriate price range for the degradation state of the battery.

FIG. 5 is a block diagram illustrating a configuration of a terminal applicable to a first terminal, a second terminal, and a third terminal of the transaction system illustrated in FIG. 1.

FIG. 6 is a flowchart for describing a process example of the transaction system illustrated in FIG. 1.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

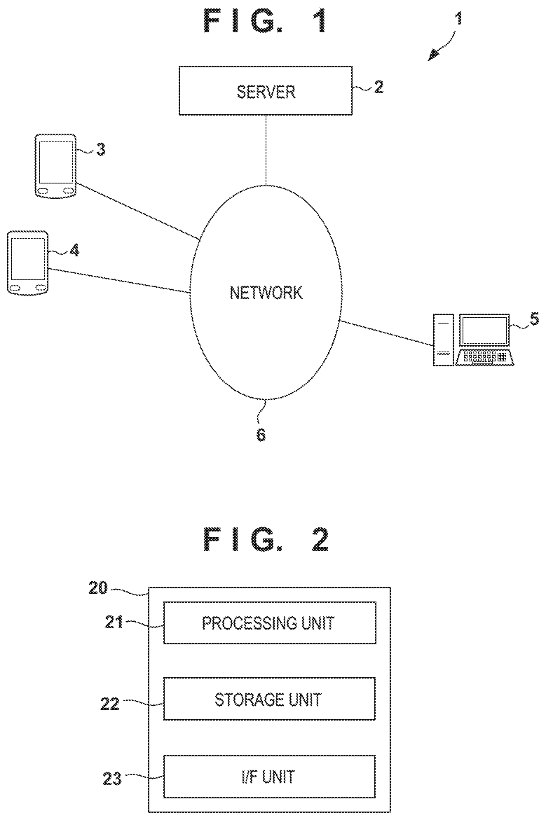

FIG. 1 is a schematic diagram illustrating a configuration of a transaction system 1, as one aspect of the present invention. The transaction system 1 is a system useful for promoting reuse of a battery, which is mounted on a vehicle that travels with an electric motor as a power source, for example, an electric vehicle or a hybrid vehicle, and which supplies electric power to the electric motor, as a reuse battery, and is used for transactions (buy or sell) of batteries. The transaction system 1 contributes to establishing a transaction of a battery between a first user (purchaser) who desires to reuse a battery mounted on a vehicle, that is, desires to purchase the battery, and a second user (owner) who owns the vehicle. Hereinafter, the battery mounted on the vehicle will be referred to as a “reuse battery”, in some cases.

As illustrated in FIG. 1, the transaction system 1 includes a server 2, a first terminal 3, a second terminal 4, and a third terminal 5. In the transaction system 1, the server 2, the first terminal 3, the second terminal 4, and the third terminal 5 are communicably connected with each other through a network 6 such as the Internet. In FIG. 1, a case where one first terminal 3 and one second terminal 4 constituting the transaction system 1 is illustrated, but there may be a plurality of first terminals 3 and a plurality of second terminals 4 constituting the transaction system 1.

The server 2 includes, for example, a computer including a CPU, a memory, and the like. In the transaction system 1, the server 2 functions as an information processing server that processes information acquired from (the first user (purchaser) who uses) the first terminal 3 and (the second user (owner) who uses) the second terminal 4 and that provides the first terminal 3 and the second terminal 4 with information.

The first terminal 3 is a terminal used by the first user who desires to reuse the battery, and is, for example, a computer or a mobile terminal including a CPU, a memory, and the like. The first terminal 3 includes a display device and a communication device. In the present embodiment, the information to be provided for the first user who uses the first terminal 3 is provided for (transmitted to) the first terminal 3 from the server 2. Here, the first user who desires to reuse the battery may be a business agency who will incorporate the battery into a secondary use product, or may be a purchaser who desires to purchase a secondary use product from such a business agency. Note that examples of the secondary use product include various products such as power generators, tillers, lawn mowers, snow blowers, and electric power storage machines.

The second terminal 4 is a terminal used by a second user who owns a vehicle that travels with an electric motor as a power source, and is, for example, a computer or a mobile terminal including a CPU, a memory, and the like. The second terminal 4 includes a display device and a communication device. In the present embodiment, the information to be provided for the second user who uses the second terminal 4 is provided (transmitted) to the second terminal 4 from the server 2.

The third terminal 5 is a terminal used by a business agency that will remove the battery from the vehicle that travels with the electric motor as the power source, and is, for example, a computer or a mobile terminal including a CPU, a memory, and the like. The third terminal 5 includes a display device and a communication device. Here, the business agency who uses the third terminal 5 is, for example, a vehicle sales dealer, a so-called dealer, provided with facilities (a factory or the like) for removing the battery from the vehicle.

FIG. 2 is a schematic block diagram illustrating a configuration of the server 2. The server 2 includes a processing unit 21, a storage unit 22, and an interface (I/F) unit 23. The processing unit 21 includes a processor represented by a CPU, and executes a program stored in the storage unit 22. The storage unit 22 includes a storage device such as a RAM, a ROM, and a hard disk. The I/F unit 23 relays transmission and reception of information between an external device and the processing unit 21. The I/F unit 23 includes a wired or wireless communication interface capable of communicating with the first terminal 3, the second terminal 4, and the third terminal 5 through the network 6.

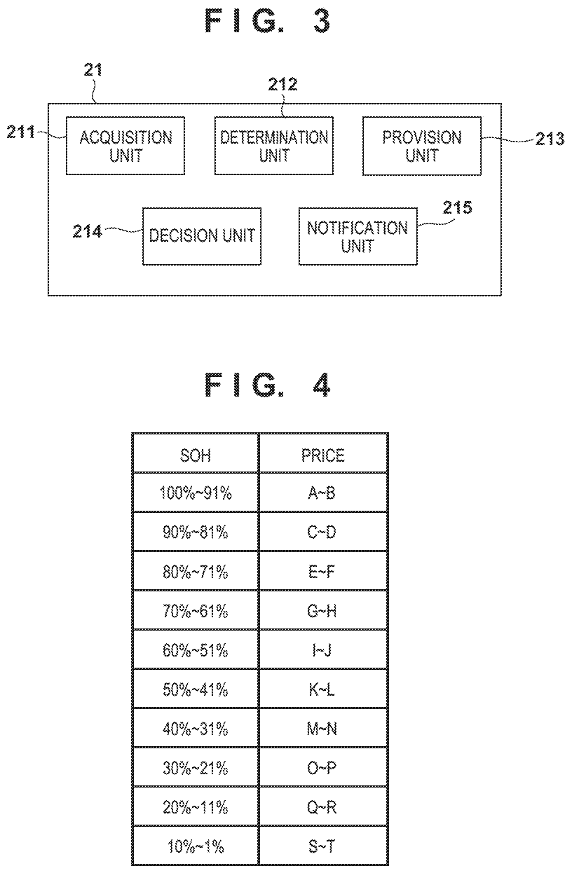

FIG. 3 is a functional configuration diagram schematically illustrating functions of the processing unit 21 in the present embodiment. In the present embodiment, as illustrated in FIG. 3, the processing unit 21 includes an acquisition unit 211, a determination unit 212, a provision unit 213, a decision unit 214, and a notification unit 215. Note that the functions (blocks) to be described below may be integrated or separated, and the functions to be described below may be implemented by different blocks. In addition, what is described as hardware may be achieved by software, and vice versa.

The acquisition unit 211 has a function of acquiring price information that includes a price to be paid for purchasing a reuse battery and that is presented by the first user, from the first terminal 3 used by the first user via the I/F unit 23. Here, the price is basically an amount of the national currency, but may be an amount of virtual currency, the number of points, or the like.

In addition, the acquisition unit 211 acquires battery information about a degradation state of the battery mounted on the vehicle owned by the second user, from the vehicle owned by the second user via the I/F unit 23. The degradation state of the battery is generally expressed by (current (degraded) full charge capacity (Ah)/initial full charge capacity (Ah))×100(%), and is also referred to as States Of Health (SOH). Note that the battery information about the degradation state of the battery can be transmitted from the vehicle via a telematics control unit (TCU) mounted on the vehicle.

The determination unit 212 determines whether the price included in the price information that has been acquired by the acquisition unit 211 is appropriate, based on the battery information that has been acquired by the acquisition unit 211. For example, as illustrated in FIG. 4, the determination unit 212 refers to a database DB indicating a relationship between a degradation state of the battery mounted on the vehicle and an appropriate price range for the degradation state of the battery, specifically, collates the battery information (degradation state of the battery) that has been acquired by the acquisition unit 211 with the database DB so as to determine whether the price presented by the first user is appropriate. Referring to the database DB illustrated in FIG. 4, “SOH” indicates a range of values of the degradation state of the battery mounted on the vehicle, and “price” indicates an appropriate range of the price for the range of the degradation state of the battery. However, the database DB illustrated in FIG. 4 is an example, and is not limited to this. For example, an appropriate range of the price for each value of the degradation state of the battery mounted on the vehicle may be made into a database. In the present embodiment, the database DB is stored in the storage unit 22 beforehand.

The provision unit 213 has a function of providing the price information that has been acquired by the acquisition unit 211 for the second user who owns the vehicle, specifically, for the second terminal 4 used by the second user via the I/F unit 23. Accordingly, (the display device of) the second terminal 4 displays the price that is to be paid for purchasing the reuse battery and that is presented by the first user. In the present embodiment, the provision unit 213 provides the second user with the price information, in a case where the determination unit 212 determines that the price included in the price information that has been acquired by the acquisition unit 211 is appropriate. On the other hand, in a case where the determination unit 212 determines that the price included in the price information that has been acquired by the acquisition unit 211 is not appropriate, the provision unit 213 does not provide the second user with the price information.

The decision unit 214 decides a business agency that will remove the battery from the vehicle, in a case where the second user who owns the vehicle approves selling of the battery at the price that is to be paid for purchasing the reuse battery and that is presented by the first user. For example, the decision unit 214 decides one business agency from a plurality of business agencies that are capable of removing the battery from the vehicle, in consideration of the place (location) of the first user and the place (location) of the second user (for example, a business agency closest to the place of the second user, a business agency closest to the place of the first user, a business agency close to both the place of the first user and the place of the second user, or the like). Note that it is sufficient if a plurality of business agencies that are capable of removing the battery from the vehicle are registered and managed in the server 2 beforehand.

In addition, the decision unit 214 decides a date and time when the battery is to be removed from the vehicle owned by the second user. For example, the decision unit 214 decides the date and time when the battery is to be removed from the vehicle owned by the second user, based on information that is related to the date and time when the battery can be removed from the vehicle and that is acquired from (the third terminal 5 installed in) the business agency via the acquisition unit 211, and information that is related to the date and time when it is possible to go to the business agency that will remove the battery from the vehicle and that is acquired from (the second terminal 4 used by) the second user via the acquisition unit 211 (that is, the date and time when the vehicle can be disposed of).

The notification unit 215 has a function of notifying the second user who owns the vehicle, specifically, the second terminal 4 used by the second user of business agency information about the business agency that will remove the battery from the vehicle and that has been decided by the decision unit 214, via the I/F unit 23. The business agency information includes at least information indicating the place of the business agency that has been decided by the decision unit 214, and further desirably includes information indicating the date and time when the battery is to be removed from the vehicle that has been decided by the decision unit 214. Accordingly, (the display device of) the second terminal 4 displays at least the place of the business agency that will remove the battery from the vehicle, and further displays the date and time when the business agency is to remove the battery from the vehicle.

In addition, in a case where the second user who owns the vehicle approves the selling of the battery at the price that is to be paid for purchasing the reuse battery and that is presented by the first user, the notification unit 215 notifies the first user, specifically, the first terminal 3 used by the first user, that the selling of the reuse battery has been approved, via the I/F unit 23.

Further, in a case where the determination unit 212 determines that the price included in the price information that has been acquired by the acquisition unit 211 is not appropriate, the notification unit 215 notifies the first user, specifically, the first terminal 3 used by the first user that reconsideration of the price to be paid for purchasing the reuse battery will be necessary, via the I/F unit 23.

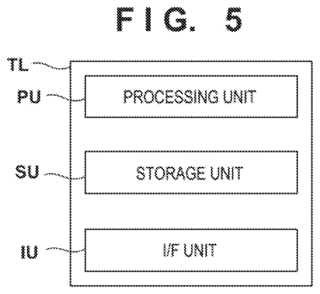

FIG. 5 is a block diagram illustrating a configuration of a terminal TL applicable to the first terminal 3, the second terminal 4, and the third terminal 5. The terminal TL includes a processing unit PU, a storage unit SU, and an interface (I/F) unit IU. The processing unit PU includes a processor represented by a CPU, and executes a program stored in the storage unit SU. The storage unit SU includes a storage device such as a RAM, a ROM, and a hard disk. The I/F unit IU relays transmission and reception of information between an external device and the processing unit PU. The I/F unit IU includes a wired or wireless communication interface capable of communicating with the server 2, the first terminal 3, the second terminal 4, and the third terminal 5 through the network 6.

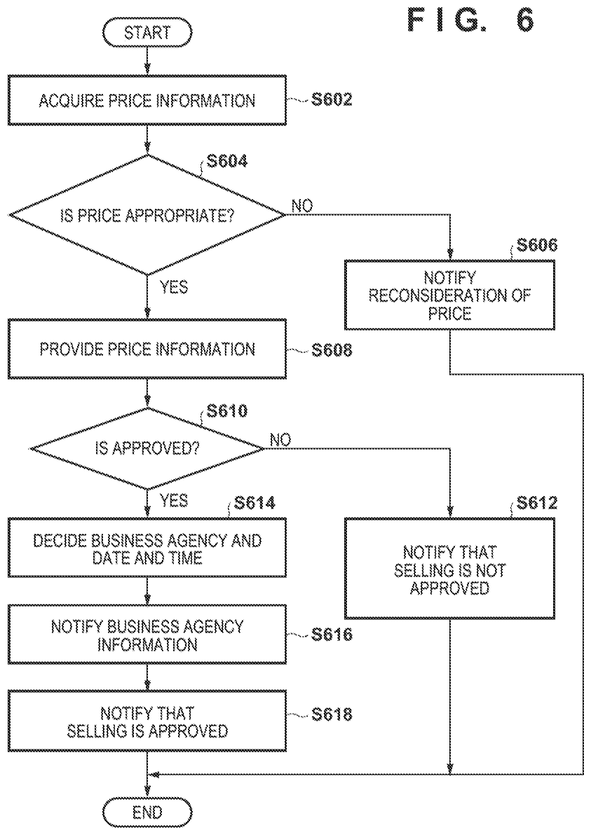

In the following, a process example of the transaction system 1 will be described with reference to FIG. 6. Here, a process example of the server 2 (a control method for the server 2) will be mainly described. In addition, it is assumed that the first user transmits, to the server 2 via the first terminal 3, the price information that includes a price to be paid for purchasing the reuse battery of a vehicle capable of traveling with the electric motor as the power source.

In 5602, the processing unit 21 (the acquisition unit 211) acquires the price information that includes the price to be paid for purchasing the reuse battery of the vehicle and that has been transmitted from the first terminal 3 used by the first user.

In 5604, the processing unit 21 (the determination unit 212) determines whether the price presented by the first user is appropriate by collating the price included in the price information acquired in S602 with the database DB stored in the storage unit 22. In a case where the price presented by the first user is not appropriate, the process proceeds to S606. On the other hand, in a case where the price presented by the first user is appropriate, the process proceeds to S608.

In S606, the processing unit 21 (the notification unit 215) notifies the first terminal 3 used by the first user that reconsideration of the price to be paid for purchasing the reuse battery of the vehicle will be necessary. In a case where the price presented by the first user is not appropriate, it is conceivable that even if the price is provided for the second user who owns the vehicle, the possibility that the second user approves selling of the battery is extremely low. Therefore, in the present embodiment, the server 2 side determines whether the price presented by the first user is appropriate, and in a case where the price presented by the first user is not appropriate, the server 2 notifies the first user that reconsideration of the price will be necessary without providing the second user with the price presented by the first user. Accordingly, the amount of information transmitted and received between the server 2 and the second terminal 4 used by the second user can be reduced (that is, unnecessary processes are omitted), and at the same time, the first user is encouraged to reconsider the price so that the opportunity for purchasing the reusable battery of the vehicle can be increased (that is, the probability of establishing a transaction of the reuse battery between the first user and the second user can be increased).

In S608, the processing unit 21 (the provision unit 213) provides the second terminal 4 used by the second user with the price information acquired in S602. Accordingly, (the display device of) the second terminal 4 displays the price to be paid for purchasing the reuse battery of the vehicle, and thus the second user is able to confirm the price presented by the first user and to decide whether to approve the selling of the reuse battery at such a price. In addition, it is possible to provide the price at which the second user highly possibly approves the selling of the battery. Note that the decision (result) of whether the second user approves the selling of the reuse battery is transmitted to the server 2 via the second terminal 4.

In S610, the processing unit 21 determines whether the second user has approved the selling of the reuse battery of the vehicle. In a case where the second user has not approved the selling of the reuse battery of the vehicle, the process proceeds to S612. On the other hand, in a case where the second user has approved the selling of the reuse battery of the vehicle, the process proceeds to S614.

In S612, the processing unit 21 (the notification unit 215) notifies the first terminal 3 used by the first user that the selling of the reuse battery at the price presented by the first user has not been approved. In this situation, similarly to S606, the first user may be further notified that reconsideration of the price will be necessary, so that the opportunity for purchasing the reuse battery of the vehicle may be increased.

In S614, the processing unit 21 (the decision unit 214) decides a business agency that will remove the battery from the vehicle, and also decides the date and time when the business agency is to remove the battery from the vehicle. In this manner, by deciding the business agency that will remove the battery from the vehicle and the date and time (that is, by guiding the business agency that is able to use the battery easily), not only a transaction of the reusable battery between the first user and the second user is established, but also the reuse of the reuse battery can be facilitated.

In S616, the processing unit 21 (the notification unit 215) notifies the second terminal 4 used by the second user of the business agency information including the information indicating the place of the business agency decided in

S614 and the information indicating the date and time. Accordingly, (the display device of) the second terminal 4 displays the place of the business agency that will remove the battery of the vehicle and the date and time, and thus the second user is able to confirm the place of the business agency that will remove the battery of the vehicle and the date and time, and to go to the business agency accordingly. Note that the business agency information including the information indicating the place of the business agency decided in S614 and the information indicating the date and time are also notified to the third terminal 5. Accordingly, the business agency is able to recognize that the battery is to be removed from the vehicle owned by the second user, that is, the vehicle is to be disposed of, and to obtain an opportunity for selling the second user a new vehicle.

In S618, the processing unit 21 (the notification unit 215) notifies the first terminal 3 used by the first user that the selling of the reuse battery of the vehicle has been approved. Accordingly, the first user is able to recognize that the selling of the reuse battery at the price that has been presented by the first user itself has been approved, that is, the first user is able to purchase the reuse battery at the price that has been presented by the first user itself

As described above, in the transaction system 1 (the server 2) in the present embodiment, basically, the price information that includes the price to be paid for purchasing the reuse battery and that is presented by the first user is acquired, and the price information is provided for the second user. In a case where the second user approves the selling of the battery at the price included in the price information, the business agency that will remove the battery from the vehicle is decided, and the business agency information about the business agency that will remove the battery from the vehicle is notified to the second user. Accordingly, it is possible to contribute to establishing a transaction of the reusable battery between the first user who desires to reuse the battery mounted on the vehicle and the second user who owns the vehicle, and also to promote reuse of the battery mounted on the vehicle as the reuse battery.

### Summary of Embodiment

1. The server (for example, 2) of the above embodiment comprising:

an acquisition unit (for example, 211) configured to acquire price information that includes a price to be paid for purchasing a battery and that is presented by a first user who desires to reuse the battery, the battery being mounted on a vehicle capable of travelling with an electric motor as a power source;

a provision unit (for example, 213) configured to provide a second user who owns the vehicle with the price information that is acquired by the acquisition unit;

a decision unit (for example, 214) configured to decide a business agency that will remove the battery from the vehicle, in a case where the second user approves selling of the battery at the price included in the price information; and

a notification unit (for example, 215) configured to notify the second user of business agency information about the business agency that is decided by the decision unit.

According to this embodiment, it is possible to contribute to establishing a transaction of the battery between the first user and the second user, and also to promote reuse of the battery mounted on the vehicle as the reuse battery.

2. The server (for example, 2) of the above embodiment, wherein

the business agency information includes information indicating a place of the business agency that is decided by the decision unit (for example, 214).

According to this embodiment, it is possible to cause the second user to recognize the place of the business agency that will remove the battery mounted on the vehicle, and to encourage the second user to go to the business agency.

3.The server (for example, 2) of the above embodiment, wherein

the decision unit (for example, 214) decides a date and time when the business agency is to remove the battery from the vehicle.

According to this embodiment, it is possible to facilitate the reuse of the battery mounted on the vehicle.

4. The server (for example, 2) of the above embodiment, wherein

the business agency information includes information indicating the date and time that is decided by the decision unit (for example, 214).

According to this embodiment, it is possible to cause the second user to recognize the date and time when the battery mounted on the vehicle is to be removed, and to encourage the second user to go to the business agency on the date and time.

5. The server (for example, 2) of the above embodiment, wherein

in a case where the second user approves the selling of the battery at the price included in the price information, the notification unit (for example, 215) notifies the first user that the selling of the battery at the price is approved.

According to this embodiment, it is possible to cause the first user to recognize that the selling of the battery at the price that has been presented by the first user has been approved.

6. The server (for example, 2) of the above embodiment, wherein

the acquisition unit (for example, 211) acquires battery information related to a degradation state of the battery,

the server further comprises a determination unit (for example, 212) configured to determine whether the price included in the price information is appropriate, based on the battery information that is acquired by the acquisition unit, and

in a case where the determination unit determines that the price included in the price information is appropriate, the provision unit (for example, 213) provides the second user with the price information.

According to this embodiment, it is possible to provide the second user with the price at which the second user highly possibly approves the selling of the battery mounted on the vehicle, and to make the second user confirm the price.

7. The server (for example, 2) of the above embodiment, wherein

in a case where the determination unit (for example, 212) determines that the price included in the price information is not appropriate,

the provision unit (for example, 213) does not provide the second user with the price information, and

the notification unit (for example, 215) notifies the first user that reconsideration of the price will be necessary.

According to this embodiment, it is possible to encourage the first user to reconsider the price, and to increase an opportunity for purchasing the battery mounted on the vehicle.

8. The server (for example, 2) of the above embodiment, wherein

the determination unit (for example, 212) determines whether the price included in the price information is appropriate, by referring to a database (for example, DB) indicating a relationship between a degradation state of the battery and an appropriate price range for the degradation state of the battery.

According to this embodiment, it is possible to easily determine whether the price included in the price information is appropriate.

9. The system (for example, 1) of the above embodiment comprising:

a server; a first terminal used by a first user who desires to reuse a battery mounted on a vehicle capable of travelling with an electric motor as a power source; and a second terminal used by a second user who owns the vehicle,

wherein the server includes:

an acquisition unit (for example, 211) configured to acquire price information that includes a price to be paid for purchasing the battery and that is presented by the first user via the first terminal;

a provision unit (for example, 213) configured to provide, via the second terminal, the second user who owns the vehicle with the price information that is acquired by the acquisition unit;

a decision unit (for example, 214) configured to decide a business agency that will remove the battery from the vehicle, in a case where the second user approves selling of the battery at the price included in the price information; and

a notification unit (for example, 215) configured to notify, via the second terminal, the second user of business agency information about the business agency that is decided by the decision unit.

According to this embodiment, it is possible to contribute to establishing a transaction of the battery between the first user and the second user, and also to promote reuse of the battery mounted on the vehicle as the reuse battery.

10. The control method of the above embodiment

is a control method for controlling a server (for example, 2), the control method comprising:

acquiring price information that includes a price to be paid for purchasing a battery and that is presented by a first user who desires to reuse the battery, the battery being mounted on a vehicle capable of travelling with an electric motor as a power source;

providing a second user who owns the vehicle with the price information that is acquired in the acquiring;

deciding a business agency that will remove the battery from the vehicle, in a case where the second user approves selling of the battery at the price included in the price information; and

notifying the second user of business agency information about the business agency that is decided in the deciding.

According to this embodiment, it is possible to contribute to establishing a transaction of the battery between the first user and the second user, and also to promote reuse of the battery mounted on the vehicle as the reuse battery.

The present invention is not limited to the above-described embodiments, and various changes and modifications can be made without departing from the spirit and scope of the present invention. Therefore, in order to make the scope of the present invention public, the following claims are attached.

1. A server comprising:
an acquisition unit configured to acquire price information that includes a price to be paid for purchasing a battery and that is presented by a first user who desires to reuse the battery, the battery being mounted on a vehicle capable of travelling with an electric motor as a power source;
a provision unit configured to provide a second user who owns the vehicle with the price information that is acquired by the acquisition unit;
a decision unit configured to decide a business agency that will remove the battery from the vehicle, in a case where the second user approves selling of the battery at the price included in the price information; and
a notification unit configured to notify the second user of business agency information about the business agency that is decided by the decision unit.

2. The server according to claim 1, wherein the business agency information includes information indicating a place of the business agency that is decided by the decision unit.

3. The server according to claim 1, wherein the decision unit decides a date and time when the business agency is to remove the battery from the vehicle.

4. The server according to claim 3, wherein the business agency information includes information indicating the date and time that is decided by the decision unit.

5. The server according to claim 1, wherein in a case where the second user approves the selling of the battery at the price included in the price information, the notification unit notifies the first user that the selling of the battery at the price is approved.

6. The server according to claim 1, wherein
the acquisition unit acquires battery information related to a degradation state of the battery,
the server further comprises a determination unit configured to determine whether the price included in the price information is appropriate, based on the battery information that is acquired by the acquisition unit, and
in a case where the determination unit determines that the price included in the price information is appropriate, the provision unit provides the second user with the price information.

7. The server according to claim 6, wherein
in a case where the determination unit determines that the price included in the price information is not appropriate,
the provision unit does not provide the second user with the price information, and
the notification unit notifies the first user that reconsideration of the price will be necessary.

8. The server according to claim 6, wherein the determination unit determines whether the price included in the price information is appropriate, by referring to a database indicating a relationship between a degradation state of the battery and an appropriate price range for the degradation state of the battery.

9. A system comprising: a server; a first terminal used by a first user who desires to reuse a battery mounted on a vehicle capable of travelling with an electric motor as a power source; and a second terminal used by a second user who owns the vehicle,
wherein the server includes:
an acquisition unit configured to acquire price information that includes a price to be paid for purchasing the battery and that is presented by the first user via the first terminal;
a provision unit configured to provide, via the second terminal, the second user who owns the vehicle with the price information that is acquired by the acquisition unit;
a decision unit configured to decide a business agency that will remove the battery from the vehicle, in a case where the second user approves selling of the battery at the price included in the price information; and
a notification unit configured to notify, via the second terminal, the second user of business agency information about the business agency that is decided by the decision unit.

10. A control method for controlling a server, the control method comprising:
acquiring price information that includes a price to be paid for purchasing a battery and that is presented by a first user who desires to reuse the battery, the battery being mounted on a vehicle capable of travelling with an electric motor as a power source;
providing a second user who owns the vehicle with the price information that is acquired in the acquiring;
deciding a business agency that will remove the battery from the vehicle, in a case where the second user approves selling of the battery at the price included in the price information; and
notifying the second user of business agency information about the business agency that is decided in the deciding.
